(19) United States
(12) Patent Application Publication
(10) Pub. No.: US 2017/0233284 A1
(43) Pub. Date: Aug. 17, 2017

(54) Methods And Systems Requiring Lubrication

(71) Applicants: Leo DIEHM, Cham (CH); Thomas L. SIDLER, North Ridgeville, OH (US); Michal T. JUDGE, Oak Harbor, OH (US); Braden A. McDERMOTH, Madison, WI (US); Robert D. GINSBERG, Tolland, CT (US); Michael SPAHR, Cham (CH); Fabrizio CORTI, Sala Capriasca (CH); Emhart Glass S.A., Cham (CH); Imerys Graphite & Carbon Switzerland SA, Bodio (CH)

(72) Inventors: Leo Diehm, Cham (CH); Thomas L. Sidler, North Ridgeville, OH (US); Michael T. Judge, Oak Harbor, OH (US); Braden A. McDermott, Monona, WI (US); Robert D. Ginsberg, Tolland, CT (US); Michael Spahr, Bellinzona (CH); Fabrizio Corti, Sala Capriasca (CH)

(21) Appl. No.: 15/501,615

(22) PCT Filed: Aug. 27, 2015
(86) PCT No.: PCT/US2015/047166

§ 371 Date: Feb. 3, 2017

Related U.S. Application Data
(60) Provisional application No. 62/049,421, filed on Sep. 12, 2014.

(51) Int. Cl. C03B 40/02

(52) U.S. Cl. CPC C03B 40/02

(57) ABSTRACT

Methods and systems in which a molten glass gob, which is processed according to the method or in the system, has a lubricant applied thereto. As it is processed in the system, the molten glass gob mass having the lubricant applied thereto is used to transfer lubricant to a part or parts of the system.

### BACKGROUND OF THE INVENTION

### Field of the Invention

The present invention relates generally to methods and systems in which a molten glass gob, which is processed according to the method or in the system, has a lubricant applied thereto, and more particularly to the molten glass gob mass having the lubricant applied thereto being used to transfer lubricant to a part or parts of the system, as it is processed in the system.

Glass containers produced on individual section (I.S.) machines are manufactured in two steps, the first of which is performed in a blank (or parison) mold that forms a glass container preform or parison, and the second of which blows the preform into the glass container. Discrete segments of molten glass referred to in the industry as glass “gobs” are sheared from a continuous stream of hot glass from a feeder, with the gobs then being distributed by a gob distributor to multiple glass delivery systems consisting of scoops, troughs, and deflectors into the respective blank molds in the section of the IS machine. This delivery of gobs into the blank molds is referred to in the industry as “loading” the blank molds.

The gobs of hot glass in the blank molds are then formed into pre-containers referred to as parisons, either by using a metal plunger to push the glass gob into the blank mold, or by blowing the glass gob out from below into the blank mold. The blank mold then opens and the parisons are inverted and transferred to blow molds, where the parisons are blown out into the shape of finished glass containers. The blown parisons are then cooled in the blow molds to the point where they are sufficiently rigid to be gripped and removed from the blow stations.

The final glass thickness distributions in the finished glass containers are to a large extent determined in the blank molds, with the exception of anomalies which may be caused by improper parison invert speed and timing. For any particular glass container design, for the most part, the manner in which the glass is distributed in the finished glass container is determined by the glass distribution in the parison. In order to obtain the proper glass distribution in the parison, it is necessary to ensure that the hot gobs load properly into the blank molds, meaning that the gobs must load deeply into the blank molds. Additionally, it is also necessary to have a slippery interface between the glass material in the gobs and the interior surfaces of the blank molds both to facilitate the molding process as well as to ensure proper release of the parisons from the blank molds.

Both of these objectives have been achieved in the industry by lubricating the interiors of the parison molds in a process referred to as “swabbing” the blank molds. The swabbing operation is typically performed by an operator using a brush dipped beforehand into a lubricant. Commercially prepared swabbing compound typically includes the same basic ingredients, namely graphite, sulfur compounds, and proprietary additives, all in a petroleum-based suspension. See, for example, U.S. Pat. No. 3,242,075, to Hunter, which teaches a high temperature lubricant consisting of graphite particles, an oil carrier, a film-forming polymer (“filomer”), and an antioxidant. Swabbing is typically performed with the I.S. machine in normal operation, although at least one gob operating cycle must be dropped to allow sufficient time to perform the swabbing operation with an acceptable degree of safety.

During the swabbing operation, the operator must manually intervene by stopping the operation of the molds long enough to swab the blank molds (and possibly the neck rings and blow mold) with the lubricant, which is a labor-intensive operation that must be done in order to prevent potential jam ups of the molding apparatus due to insufficient lubricant. Further, the lubrication of the blank molds is often done on an at least somewhat irregular basis, which may vary the degree to which the blank molds are lubricated. Still further, the quantity of the lubricant deposited inside the blank mold may be more or less than the necessary quantity, and the deposited lubricant inside the blank mold may be uneven. Thus, it will be appreciated that swabbing as an operation is far from precise and as such is at least somewhat irregular.

Alternatives to manual swabbing have been proposed. Several examples of such alternatives provide different methods of applying the lubricant to the blank molds. U.S. Pat. No. 5,597,396, to Tohjo, teaches a robot swabbing device that carries a swabbing member rubbing a swabbing lubricant onto blank molds. U.S. Pat. No. 8,375,743, to Zanella et al., teaches a process for spraying lubricant through a spray tube inserted into the blank molds. While both of these devices have the advantage of reducing the danger to the machine operator, they both also have the potential disadvantage of being imprecise in their application of lubricant into the blank molds.

There are several potential downsides of both manual swabbing of the blow molds and either robot swabbing of the blank molds or spraying lubricant into the blow molds. First, the blank mold surface may be temporarily chilled by the swabbing compound, yielding heavier sidewalls and lighter bases. Second, and more frequently, heat transfer across the glass-blank mold interface may be reduced due to thermal insulation incident to the swabbing compound, which would result in the blank molds “running hot,” which will result in lighter sidewalls and heavier bases.

One other unsuccessful approach that has been taken is shown in U.S. Pat. No. 4,526,600, to Myers, which teaches spraying falling glass gobs with a flame spray lubricating device with forced air burners having graphite delivered thereto through a fluidized bed and air feed arrangement, and the apparatus for performing this operation, which is shown in U.S. Pat. No. 4,880,454, to Beningo, which flame sprays the powdered graphite directly onto falling hot gobs from two sides of the gobs and uses vacuum exhaust headers to collect overspray from the powdered graphite sprays. The flame spraying process is rather complex and costly, and does not apply the graphite powder specifically to the glass gob which leads to overspray, which results in the accumulation of graphite powder in the area of the I.S. machine. Since it is impossible to collect anything close to all of the sprayed power graphite, and since finely powdered graphite could also potentially be inhaled which is of course problematic, the Myers method and the Beningo system are undesirable in a glass container manufacturing environment. Thus, manual or robot swabbing or spraying lubricant directly onto the blank molds has remained the only viable way to lubricate the blank molds, even though these techniques all have the well-known deficiencies discussed above.

Also of interest in the technical field of the invention are U.S. patent application Ser. No. 13/833,168, filed on Mar. 15, 2013, and U.S. patent application Ser. No. 14/184,383, filed Feb. 19, 2014, both entitled “System and Method to Coat Glass Gobs With A Lubricating Dispersion During The Drop To Blank Molds,” which patent applications are each assigned to the assignees of the present patent application, and which patent applications are both hereby incorporated herein by reference in their entirety.

It may be appreciated that in a system requiring lubrication in which a liquid-based lubricating dispersion including a solid lubricant is applied to a molten glass gob which is to be processed in the system, it may be desirable to improve the efficiency of the system and/or to reduce waste in the system.

The subject matter discussed in this background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

### SUMMARY OF THE INVENTION

The disadvantages and limitations of the background art discussed above are overcome by the present invention. With this invention, in a system requiring lubrication in which a liquid-based lubricating dispersion including a solid lubricant is applied to a molten glass gob which is to be processed in the system, the efficiency of the system is improved and/or waste is reduced.

According to a first aspect, there is provided a method of lubricating a surface of a part or parts of a system using one or more molten glass gobs having a lubricant dispersion including a solid lubricant applied thereto to transfer lubricant to said part or parts of the system is provided in which:
(i) the amount of lubricating dispersion applied to the molten glass gob is such that an amount of lubricant that transfers from the molten glass gob to a surface of the part or parts of the system with which the molten glass gob comes into contact is sufficient for lubricating the part(s) during at least one further processing cycle of a molten glass gob which is to be processed in the system; and/or
(ii) the amount of lubricating dispersion applied to the molten glass gob is such that the next molten glass gob to be processed in the same shaping means in a subsequent processing cycle is applied with a lower dosage of dispersion; and/or
(iii) the amount of lubricating dispersion applied to the molten glass gob is such that no dispersion is applied to the next molten glass gob which is to be processed in the same shaping means in a subsequent processing cycle; and/or
(iv) the solid lubricant is graphite; and/or
(v) the only solid lubricant is graphite; and/or
(vi) the solid lubricant has a d₉₀ of less than about 150 microns; and/or
(vii) the lubricant dispersion is water-based; and/or
(viii) the lubricant dispersion comprises dispersant and/or rheology modifier; and/or
(ix) the molten glass gob is stationary as the lubricating dispersion is applied; and or
(x) the lubricating dispersion applied does not produce carbon black following application to the molten glass gob and/or during processing of the molten glass gob into a shaped article; and/or
(xi) the temperature, for example, bulk temperature of the molten glass gob is not adversely affected by application of the lubricating dispersion.

According to a second aspect, there is provided a method for improving the efficiency of a system requiring lubrication applies a liquid-based lubricating dispersion including a solid lubricant to a molten glass gob which is to be processed in the system, such that or whereby the efficiency of the system is improved.

According to a third aspect, there is provided a method for reducing waste in a system requiring lubrication applies a liquid-based lubricating dispersion including a solid lubricant to a molten glass gob which is to be processed in the system, such that or whereby waste is reduced.

According to a fourth aspect, there is provided a method of increasing the utilization rate of shaping means in a system for shaping a molten glass gob applies a liquid-based lubricating dispersion including a solid lubricant to the molten glass gob prior to shaping the molten glass gob in the shaping means.

According to a fifth aspect, there is provided a method of reducing the amount of lubricant used in a system requiring lubrication applies a liquid-based lubricant dispersion to a molten glass gob to be processed in the system such that lubricant is transferred from the molten glass gob to a part of parts of the system requiring lubrication, thereby reducing the amount of lubricant used in the system.

### DETAILED DESCRIPTION OF EXEMPLARY EMBODIMENTS

The methods and systems described herein are directed to improving the efficiency of manufacturing systems requiring lubrication. The methods and systems described herein a further directed to reducing waste in manufacturing systems requiring lubrication. Such improvements in efficiency and reduction in waste may be obtained through methods of applying lubricant to a part or parts of the system requiring lubrication during normal operation. Such improvements in efficiency and reduction in waste may be assessed relative to comparable methods and systems in which (A) a lubricant is applied either (i) manually to a part or parts of the system, or (ii) by flame or plasma spraying a glass gob which is to be processed in the system, or (B) the lubricating composition applied produces carbon black following application to the glass gob and/or during processing of the glass gob into a shaped article.

Improvements in efficiency/reductions in waste may include:

a reduction in energy usage, e.g., electrical and/or mechanical energy, during operation of the system and method;

a reduction in the number of working parts of the system or method;

simplification or elimination of control aspects;

a reduction in wear and maintenance of parts and associated operating downtime;

a reduction in wastage of partially used materials, e.g., lubricant which has been used but not spent (i.e., retains acceptable lubricating properties);

reduction in the amount of waste by-products generated, e.g., volatile gaseous species, such as volatile organics;

improving the lifetime of raw materials;

reducing levels of substandard production articles, for example, resulting from over-application (or under-application) of lubricant during processing, thereby increasing productivity; and

increased automation of the lubricating function, reducing need for human intervention and associated labor costs, as well as improving safety by reducing the number of, or eliminating the need for, human interventions.

In certain embodiments, efficiency is improved by at least about 1 percent, for example, at least about 2 percent, or at least about 5 percent, or at least about 10 percent, or at least about 15 percent, or at least about 20 percent, or at least about 25 percent. In certain embodiments, waste is reduced by at least 1 percent, or at least about 2 percent, or at least about 5 percent, or at least about 10 percent, or at least about 15 percent, or at least about 20 percent, or at least about 25 percent. As described above, the improvement in efficiency and reduction in waste may be assessed relative to comparable methods and systems in which (A) a lubricant is applied either (i) manually to a part or parts of the system, or (ii) by flame or plasma spraying a glass gob which is to be processed in the system, or (B) the lubricating composition applied produces carbon black following application to the glass gob and/or during processing of the glass gob into a shaped article, for example, by comparing one or more of (i) unit cost, (ii) energy consumption (iii) lubricant consumption and (iv) waste produced per glass gob processed in the system.

Reducing waste may include reducing the amount of volatile gaseous material (e.g., volatile organic material) generated during the processing of a glass gob, for example, by reducing the amount of volatile gaseous materials produced as the lubricating dispersion is applied to the glass gob and/or during further processing of the glass gob in the method and system. For example, by having solid lubricant in the lubricating dispersion, the amount of volatalizable and/or vaporizable material in the lubricating dispersion may be reduced, even eliminated. Additionally, there are environmental and health benefits in reducing the amount of volatile gaseous materials generated during the processing of the glass gobs. Further, improvements in efficiency may ensue because less waste needs to be dealt with, e.g., contained or removed or disposed of.

Thus, in certain embodiments, reducing waste includes reducing the amount of volatile gaseous material generated during process of a glass gob. For example, the amount of volatile gaseous material waste may be reduced by at least about 1 percent, or at least about 2 percent, or at least about 5 percent, or at least about 10 percent, or at least about 15 percent, or at least about 20 percent, or at least about 25 percent.

According to said methods, the molten glass gob having lubricant dispersion applied thereon is used to transfer lubricant in the system, i.e., to transfer lubricant to a part or parts of the system with which the molten glass comes into contact during processing into a glass article.

In certain aspects, the glass gob having lubricant dispersion applied thereon is used to transfer lubricant in the system. As such, there is provided an automated method of lubricating a surface of a part or parts of a system using one or more glass gobs having a lubricant dispersion including a solid lubricant applied thereto to transfer lubricant to said part or parts of the system.

In certain embodiments, there is provided an automated method of lubricating a surface of a part or parts of a system using one or more glass gobs having a lubricant dispersion including a solid lubricant applied thereto as a vehicle for transferring lubricant to said part or parts of the system.

In certain embodiments, there is provided an automated method of lubricating a surface of a part or parts of a system using one or more glass gobs having a lubricant dispersion including a solid lubricant applied thereto, wherein the one or more glass gobs act as a carrier for transferring lubricant to said part or parts of the system.

In certain embodiments: (i) the amount of lubricating dispersion applied to the glass gob is such that an amount of lubricant that transfers from the glass gob to a surface of a part or parts of the system with which the glass gob comes into contact is sufficient for lubricating the part(s) during at least one further processing cycle of a glass gob which is to be processed in the system; and/or (ii) the amount of lubricating dispersion applied to the glass gob is such that the next glass gob to be processed in the same shaping means in a subsequent processing cycle is applied with a lower dosage of dispersion; and/or (iii) the amount of lubricating dispersion applied to the glass gob is such that no dispersion is applied to the next glass gob which is to be processed in the same shaping means in a subsequent processing cycle; and/or (iv) the only solid lubricant is graphite; and/or (v) the only lubricant is graphite; and/or (vi) the solid lubricant has a d₉₀ of less than about 150 microns; and/or (vii) the lubricant dispersion is water-based; and/or (viii) the lubricant dispersion comprises dispersant and/or rheology modifier; and/or (ix) the glass gob is stationary as the lubricating dispersion is applied; and or (x) the lubricating dispersion applied does not produce carbon black following application to the glass gob and/or during processing of the glass gob into a shaped article; and/or (xi) the temperature, for example, surface temperature of the glass gob does not decrease by more than about 20° C. upon application of the lubricating dispersion.

### The Lubricating Dispersion

The lubricating dispersion comprises a lubricant. In certain embodiments, the lubricating dispersion comprises, consists essentially of, or consists of, a solid lubricant. In certain embodiments, a solid lubricant is the sole or only lubricant present in the lubricating dispersion. In certain embodiments, the lubricating dispersion does not comprise, or is free of, any material which may form (i.e., be converted to) as a solid lubricant upon or during application of the liquid dispersion to the glass gob.

The lubricant, e.g. solid lubricant, is applied to the glass gob via a lubricating dispersion including the lubricant. The solid lubricant may be in powder form. In certain embodiments, the solid lubricant is or comprises a solid lubricant selected from graphite, molybdenum disulfide, tungsten disulfide, hexagonal boron nitride or mixtures thereof. In certain embodiments, the solid lubricant is or comprises graphite. In certain embodiments, the solid lubricant comprises, consists essentially of, or consists of graphite. In certain embodiments, graphite is the sole or only lubricant present in the lubricating dispersion. In certain embodiments, graphite is the sole or only solid lubricant present in the lubricating dispersion. The graphite may be synthetic and/or natural in origin. In certain embodiments, the graphite is synthetic. In certain embodiments, the graphite is natural.

In certain embodiments, the solid lubricant, for example, graphite, has a particle size characterized by a d₉₀ of less than about 150 microns (90 percent of the particles are smaller than 150 microns), or less than about 75 microns, or less than about 50 microns measured by a laser diffraction device such as the Malvern Mastersizer S with sample dispersion unit (see the measurement methods below). In certain embodiments, the solid lubricant is Timrex® KS 44 graphite, which is available from Timcal Graphite & Carbon, a member of IMERYS, which has a d₉₀ of approximately 44 microns. The lubricant, for example, graphite lubricant, could include particle sizes in the submicron range such as, for example, colloidal graphite. In certain embodiments, the lubricant, for example, graphite lubricant does not comprise particle sizes in the submicron range. In certain embodiments, the graphite is not, or does not comprise, colloidal graphite. In certain embodiments, the graphite includes exfoliated graphite. In certain embodiments, the lubricant includes graphene.

A brief description of a measuring method using particle size distribution by laser diffraction will now be briefly presented. The presence of particles within a coherent light beam causes diffraction. The dimensions of the diffraction pattern are correlated with the particle size. A parallel beam from a low-power laser lights up a cell which contains the sample suspended in water. The beam leaving the cell is focused by an optical system. The distribution of the light energy in the focal plane of the system is then analyzed. The electrical signals provided by the optical detectors are transformed into by means of a calculator. The particle size distribution is typically expressed in volume fraction below a specific particle diameter: d₉₀ means 90 percent of the volume of the particles has a diameter below the given value. A small sample of graphite is mixed with a few drops of wetting agent and a small amount of water. The sample prepared in the described manner is introduced in the storage vessel of the apparatus and measured. Applicable standards include ISO 13320 1 and ISO 14887.

In certain embodiments, the lubricating dispersion does not comprise carbon black. In certain embodiments, the lubricating dispersion does not produce carbon black following application to the glass gob and/or during processing of the glass gob into a shaped article. In certain embodiments, the lubricating dispersion does not comprise, or is substantially free of, a component or components, for example, a carboniferous component or components, which produce carbon black when heated to a sufficiently high temperature, e.g., when combusted.

In certain embodiment, the lubricating dispersion is a liquid-based dispersion, optionally with the liquid base making up from about 50 percent by weight to about 98 percent by weight of the lubricating dispersion, for example, from about 60 percent by weight to about 80 percent by weight of the lubricating dispersion, or from about 65 percent by weight to about 75 percent by weight of the lubricating dispersion. In certain embodiments, the lubricating dispersion is water-based. In certain embodiments, the lubricating dispersion is an organic solvent-based dispersion in which the lubricating solid is dispersed in an organic solvent such as mineral oil, vegetable oil, iso propanol, or methyl ethyl ketone. Stabilizing additives or agents that can be used with organic solvent-based dispersions include hydrogenated castor oil derivatives like RHEOCIN® Mastergels from Rockwood Specialties Group of Princeton, N.J., ISCATHIX® ISP from Isca UK LTD of Wales, UK, organophilic bentonites like TIXOGEL® VP V (Quaternium 90 Bentonite) and TIXOGEL® VZ V (Stearalkonium Bentonite) from Rockwood Specialties Group, or pre activated amide waxes like CRAYVALLAC® PA3 from Arkema Coated Resins of Cary, N.C.

The lubricating dispersion may additionally comprise a dispersing agent (a wetting agent), a rheological modifier, and/or other lubricant additives.

In certain embodiments, the dispersing agent is a PEO PPO PEO block copolymer. Alternative dispersing agents are ionic dispersants like sulphonates, non-ionic dispersants like alcohol polyethoxylates, or alkyl polyether, or any other dispersants known to those skilled in the field of pigment dispersion. The dispersing agent may constitute from about 0.01 percent to about 20 percent by weight of the lubricating dispersion, for example, from about 0.1 percent to about 5 percent of the lubricating dispersion, or from about 0.25 percent to about 1 percent of the lubricating dispersion.

The rheological modifier may serve as a thickener and, in certain embodiments, is a polysaccharide or Xanthan gum. Alternative rheological modifiers are inorganic thickeners like phillosilicates, or other organic thickeners like carboxy methyl cellulose or cellulose ethers, or like polyacrylates, or like polyurethanes, or any other thickeners known to those skilled in the fields of pigment dispersion. The rheological modifier may constitute from about 0.01 percent by weight to about 25 percent by weight of the lubricating dispersion, for example, from about 0.1 percent to about 5 percent by weight of the lubricating dispersion, or from about 0.15 to about 1 percent of the lubricating dispersion.

In certain embodiments, other lubricant additives may be included such as binder materials like inorganic binder materials such as silicates, or organic binder materials like polyvinyl acetates, or polyurethanes. The binder may function to enhance lubricant adhesion to the glass gob and/or the part or parts of the system requiring lubrication, therefore enhancing the lubrication qualities of the dispersion. In certain embodiments, binder constitutes from about 0.01 percent to about 30 percent by weight, for example, from about 0.1 to about 15 percent by weight, or from about 1 percent to about 10 percent of the lubricating dispersion.

Additional lubricants additives that may be included are a pH modifier like ammonia or amines, or any other pH modifier known to those skilled in the field of pigment dispersion. Other lubricants additives are a defoamer like mineral oils or a silicon based or equivalent defoamer known to those skilled people in the field of pigment dispersion. Preservatives or biocides can also be included in the dispersion to improve its shelf life.

In certain embodiments, the lubricating dispersion comprises less than about 50 percent by weight of volatalizable and/or vaporizable material, excluding any water in the dispersion, for example, less than about 40 percent by weight, or less than about 30 percent by weight, or less than about 20 percent by weight, or less than about 15 percent by weight, or less than about 10 percent by weight, or less than about 5 percent by weight, or less than about 2 percent by weight, or less than about 1 percent by weight of volatalizable and/or vaporizable material. In certain embodiments, excluding any water present, the lubricating dispersion is essentially free of volatalizable and/or vaporizable material.

In certain embodiments, the molten glass gob is formed from a composition comprising one or more of cullet, quartz sand, and soda. The term “cullet” used herein refers to raw glass, broken glass from a cooled melt or scrap glass intended for recycling, and is generally plant generated or recycled from the market place. Included is any type of broken refuse glass, such as but not limited to container glass (e.g. recyclable glass jars or bottles), of all colors, uncolored glass, tinted or untinted plate glass (e.g. window panes), and mixtures thereof.

In certain embodiments, the molten glass gob is formed from a composition comprising at least about 20 percent by weight cullet, for example, from about 20 to about 90 percent by weight cullet, for example, from about 30 to about 90 percent by weight cullet, or from about 40 to about 90 percent cullet, or from about 50 to about 90 percent cullet, or from about 60 to about 90 percent by weight cullet.

In certain embodiments, the cullet comprises or is a silica glass cullet, for example a soda-lime glass cullet. Soda-lime cullet is a common commercial glass and generally the least expensive to produce. Soda-lime glass is used primarily for bottles and jars and typically comprises from about 60-75 percent by weight silica, from about 12 to 18 percent by weight soda and from about 5 to 12 percent by weight lime.

### Application of the Lubricating Dispersion

In certain embodiments, the lubricating dispersion is applied to the glass gob prior to contact with a part or parts of the system in which the glass gob is processed to form a shaped article. In certain embodiments, the part or parts include a surface of a shaping means in which the glass gob is shaped and/or a surface of delivery means for conveying the glass gob to the shaping means. In certain embodiments, the lubricating dispersion is applied to the glass gob prior to contact with any part or parts of the system in which the glass gob is produced to form a shaped article. In certain embodiments, the lubricating dispersion is applied prior to contact with any delivery means for conveying the glass gob to the shaping means.

In certain embodiments, the shaping means is a mold, for example, a blow mold and/or a blank mold, and at least a portion of lubricant transfers from the glass gob to at least a portion of an inner surface of the mold as the glass gob comes into contact with the mold, e.g., loaded or delivered or directed into the mold. In other embodiments, the shaping means is a dye, or a press, or an extruder.

In certain embodiments, the delivery means for conveying the glass gob comprises one or more of a scoop, trough, chute, guide-track, director, deflector or any other means suitable for guiding or directing the glass gob between a point of formation of the glass gob and the shaping means.

In certain embodiments, the glass gob is in motion during application of the lubricating dispersion, for example, in free fall.

In certain embodiments, the glass gob is stationary as the lubricating dispersion is applied. For example, in certain embodiments, the lubricating dispersion is applied immediately following forming of the glass gob and before the glass gob is released or otherwise set apart from a gob forming means.

In certain embodiments, the method according to any preceding claim, wherein the glass gob is (i) enclosed as the lubricating dispersion is applied, or (ii) is not enclosed as the lubricating dispersion is applied.

In certain embodiments, the amount of lubricating dispersion to be applied is sufficient to cover, coat or extend about at least a portion of the surface of the glass gob. In certain embodiments, the amount of lubricant dispersion applied is sufficient to cover, coat or extend about from about 1 percent to about 99 percent of the surface area of the glass gob, for example, from about 1 percent to about 75 percent, or from about 1 percent to about 50 percent, or from about 1 percent to about 40 percent, or from about 1 percent to about 30 percent, or from about 1 percent to about 20 percent, or from about 1 percent to about 10 percent. For example, the amount of lubricant dispersion applied may be sufficient to cover, coat or extend about at least about 2 percent of the surface area of the glass gob, for example, at least about 5 percent, or at least about 10 percent, or at least about 15 percent, or at least about 20 percent of the surface area of the glass gob.

In certain embodiments, the amount of lubricating dispersion applied, e.g., sprayed, to the glass gob is such that (i) an amount of lubricant transfers from the glass gob to a surface(s) of the part(s) of the system with which the glass gob comes into contact and which is sufficient for lubricating the part(s) during at least one subsequent processing cycle of a further glass gob.

In certain embodiments in which the glass gob is shaped in a shaping means, the amount of lubricating dispersion applied, e.g., sprayed, to the glass gob is such that the next glass gob to be processed in the same shaping means in a subsequent processing cycle is applied with a lower dosage of lubricating dispersion.

In certain embodiments in which glass gob is shaped in a shaping means, the amount of lubricating dispersion applied, e.g., sprayed, to the glass gob is such that no dispersion needs to be applied to the next glass gob which is to be processed in the same shaping means in a subsequent processing cycle.

Because not every glass gob in a series of processing cycles needs to have lubricating applied, or may have a lower amount of lubricating dispersion applied compared to a glass gob in a previous processing cycle, lubricant may be used more efficiently.

For example, in a continuous method in which two or more (or a plurality of) glass gobs are processed sequentially in the system in a given period of time, the lubricating dispersion may be applied to no more than every other glass gob in the sequence, or no more than every second glass gob in the sequence, or no more than every third glass gob in the sequence, or no more than every fourth glass gob in the sequence, or no more than about fifth glass gob in the sequence, or no more than every sixth glass gob in the sequence, or no more than every seventh glass gob in the sequence, or no more than every eighth glass gob in the sequence, or no more than every ninth glass gob in the sequence, or no more than every tenth glass gob in the sequence, and so on. In certain embodiments, less than about 50 percent of the glass gobs have lubricating dispersion applied, for example, less than about 40 percent, or less than about 30 percent, or less than about 20 percent, or less than about 10 percent, or less than about 5 percent, or less than about 2 percent, or less than about 1 percent of the glass gobs have lubricating dispersion applied. Because not every glass gob in the sequence must necessarily have lubricating dispersion applied thereto, the efficiency of the method and system may be improved.

In certain embodiments, in each processing cycle two or more (or a plurality of) glass gobs are processed essentially simultaneously.

In certain embodiments, a glass gob is part of an array of like gobs which are processed essentially simultaneously. An array may comprise two, or three, or four, or five, or more like glass gobs arranged linearly, or in any other special arrangement which enables essentially simultaneous processing in a processing cycle. In such embodiments, a processing cycle means processing of one array of glass gobs. Thus, for example, if 10 cycles of an array consisting of four like glass gobs are processed, 40 glass gobs in total would have been processed during the 10 cycles.

Thus, in certain aspects, there is provided a method of increasing the utilization rate of shaping means, e.g., mold, in a system for shaping a glass gob, said method comprising applying a lubricating dispersion including a solid lubricant to the glass gob prior to shaping the glass gob in the shaping means, e.g., mold, as well as a method of reducing the amount of lubricant used in a system requiring lubrication, said method comprising applying a lubricant dispersion to a glass gob to be processed in the system such that lubricant is transferred from the glass gob to a part of parts of the system requiring lubrication, thereby reducing the amount of lubricant used in the system. The increase in utilization rate and/or reduction in the amount of lubricant used may be assessed relative to comparable methods and systems in which (A) a lubricant is applied either (i) manually to a part or parts of the system, or (ii) by flame or plasma spraying a glass gob which is to be processed in the system, or (iii) to every glass gob which is processed according to the method or in the system; or (B) the lubricating composition applied produces carbon black following application to the glass gob and/or during processing of the glass gob into a shaped article, for example, by comparing the number of glass gobs processed in the system in any given period of time, or by comparing the amount of lubricant consumed in the system per glass gob process in the system. In certain embodiments, the utilization rate of the shaping means is increased by at least about 1 percent, or at least about 2 percent, or at least about 3 percent, or at least about 4 percent, or at least about 5 percent, or at least about 6 percent, or at least about 7 percent, or at least about 8 percent, or at least about 9 percent, or at least about 10 percent. In certain embodiment, the amount of lubricant used is reduced by at least about 1 percent, or at least about 2 percent, or at least about 5 percent, or at least about 10 percent, or at least about 15 percent, or at least about 20 percent, or at least about 25 percent.

As described above, in certain embodiments, the lubricating dispersion is applied by spraying. As used herein, the term “spraying” does not include flame spraying or plasma spraying. The lubricating dispersion may be sprayed via or from one or more, e.g., two or more (or a plurality of), points about the glass gob. In certain embodiments, the lubricating dispersion is applied via one or more, e.g., two or more (or a plurality of), apertures located about the glass gob.

In other embodiments, the lubricating dispersion is applied as the glass gob passes through or is passed through or is contacted with or contacts a body of lubricant dispersion. The body may be a pool or a layer or thin film of lubricating dispersion.

The lubricating dispersion may be applied by dipping at least portion of, or submersing, the glass gob into the lubricating dispersion, particularly in embodiments in which the glass gob has a temperature, for example, a surface temperature which is cooler than about 100° C. In certain embodiments, the lubricating dispersion comprising a solid lubricant is applied to a combustible (e.g., at temperatures above about 50° C.) and/or frangible film or layer and solid lubricant adheres to the glass gob as it passes through or is passed through the combustible and/or frangible film or layer.

In certain embodiments, the lubricating dispersion comprising a solid lubricant is applied by brushing.

In certain embodiments, the solid lubricant is applied by electrostatic discharge on the molten glass gob as it passes or is passed through a lubricating dispersion comprising powdered solid lubricant.

In certain embodiments, the temperature, for example, bulk temperature, of the glass gob is not adversely effected upon application of the lubricating dispersion. By “not adversely affected” is meant the bulk temperature of the molten glass gob may vary (e.g., cool) upon application of the lubricant, but not to the extent that the overall process for manufacturing a glass article from the molten glass gob needs to be adjusted to compensate for any variance in bulk temperature. In certain embodiments, the bulk temperature of the molten glass gob does not decrease by more than about 20° C. upon application of the lubricating dispersion, for example, does not decrease by more than about 15° C., or does not decrease by more than about 10° C., or does not decrease by more than about 5° C., or does not decrease by more than about 2° C., or does not decrease by more than about 1° C. upon application of the lubricating dispersion. In certain, the temperature, for example, bulk temperature of the glass gob does not decrease by less than about 1° C., or does not decrease, upon application of the lubricating dispersion.

In certain embodiments, the lubricating dispersion is heated prior to application or during application. The lubricating dispersion may be heated to a temperature above about 50° C., or above about 75° C.

In certain embodiments, the glass gob may have a temperature, for example, surface temperature, of at least about 200° C., for example, or at least about 300° C., or at least about 400° C., or at least about 500° C., or at least about 750° C. or at least about 1000° C. or at least about 1250° C. or at least about 1500° C. In certain embodiments, the temperature is less than about 2000° C.

As described herein, in certain embodiments, the glass gob is processed by shaping, e.g., molding, into a shaped article. Articles which may be manufactured according to the methods and systems are many and various and include, for example, shaped glass articles, for example, glass containers, such as bottles and jars.

In certain embodiments, the method of any aspect further comprises forming (e.g., molding) a glass article, e.g., container, from the molten glass gob and inspecting the glass article, e.g., for defects. Inspection may be manual and/or automated. In certain embodiments, the method of any aspect further comprises forming (e.g., molding) a glass article, e.g., container, from the molten glass gob and packaging the glass article for distribution, for example, packaging the glass container for transportation to a customer facility. In certain embodiments, the glass article is inspected (e.g., manually and/or automatically) and then packaged for distribution.

For the avoidance of doubt, the present application is also directed to the subject-matter described in the following numbered paragraphs:
1. A method for improving the efficiency of a system requiring lubrication, the method comprising applying a liquid-based lubricating dispersion including a solid lubricant to a molten glass gob which is to be processed in the system, such that or whereby the efficiency of the system is improved.
2. A method of reducing waste in a system requiring lubrication, the method comprising applying a liquid-based lubricating dispersion including a solid lubricant to a molten glass gob which is to be processed in the system, such that or whereby waste is reduced.
3. A method according to paragraph 1 or 2, wherein efficiency is improved and/or waste is reduced relative to a system in which (A) a lubricant is applied either (i) manually to a part or parts of the system or (ii) by flame or plasma spraying a molten glass gob, or (B) the lubricating composition applied produces carbon black following application to the molten glass gob and/or during processing of the molten glass gob into a shaped article.
4. A method according to any preceding paragraph, wherein efficiency is improved by and/or waste is reduced by at least about 1 percent, for example, at least about 2 percent, or at least about 5 percent, or at least about 10 percent.
5. A method according to any preceding paragraph, wherein the lubricating dispersion is applied to the molten glass gob prior to contact with a part or parts of the system in which the molten glass gob is processed to form a shaped article.
6. A method according to any preceding paragraph, wherein the amount of lubricating dispersion applied to the molten glass gob is such that (i) an amount of lubricant transfers from the molten glass gob to a surface(s) of the part(s) of the system in which the molten glass gob comes into contact and which is sufficient for lubricating the part(s) during at least one subsequent processing cycle of a further molten glass gob, or (ii) the next molten glass gob to be processed in the same shaping means in a subsequent processing cycle is applied with a lower dosage of dispersion, or (ii) no dispersion is applied to the next molten glass gob which is to be processed in the same shaping means in a subsequent processing cycle.
7. A method according to any preceding paragraph, wherein the molten glass gob is in motion, for example, free falling as the lubricating dispersion is applied.
8. A method according to any one of paragraphs 1-7, wherein the molten glass gob is stationary as the lubricating dispersion is applied.
9. A method according to paragraph 8, wherein the lubricating dispersion is applied immediately following forming of the molten glass gob.
10. A method according to any preceding paragraph, wherein the molten glass gob is (i) enclosed as the lubricating dispersion is applied, or (ii) is not enclosed as the lubricating dispersion is applied.
11. A method according to any preceding paragraph, wherein two or more molten glass gobs are processed sequentially in the system in a given period of time, and wherein the lubricating dispersion is applied to no more than every other molten glass gob in the sequence.
12. A method according to any preceding paragraph, wherein two or more of like molten glass gob are processed essentially simultaneously in the system.
13. A method of increasing the utilization rate of shaping means in a system for shaping a molten glass gob, said method comprising applying a lubricating dispersion including a solid lubricant to the molten glass gob prior to shaping the molten glass gob in the shaping means.
14. A method of reducing the amount of lubricant used in a system requiring lubrication, said method comprising applying a lubricant dispersion to a molten glass gob to be processed in the system such that lubricant is transferred from the molten glass gob to a part of parts of the system requiring lubrication, thereby reducing the amount of lubricant used in the system.
15. A method according to paragraph 13 or 14, wherein the utilization rate is increased and/or reduction in the amount of lubricant used is reduced relative to a system in which (A) a lubricant is applied either (i) manually to a part or parts of the system, or (ii) by flame or plasma spraying a molten glass gob which is to be processed in the system, or (iii) to every molten glass gob which is processed according to the method or in the system; or (B) the lubricating composition applied produces carbon black following application to the molten glass gob and/or during processing of the molten glass gob into a shaped article.
16. A method according anyone of paragraphs 13-15, wherein the utilization rate is increased by, and/or the amount of lubricant used is reduced by, at least 1 percent.
17. An automated method of lubricating a surface of a part or parts of a system using one or more molten glass gob having a lubricant dispersion including a solid lubricant applied thereto to transfer lubricant to said part or parts of the system.
18. An automated method according to paragraph 17, wherein:
   (i) the amount of lubricating dispersion applied to the molten glass gob is such that an amount of lubricant that transfers from the molten glass gob to a surface of the part or parts of the system with which the molten glass gob comes into contact is sufficient for lubricating the part(s) during at least one further processing cycle of a molten glass gob which is to be processed in the system; and/or
   (ii) the amount of lubricating dispersion applied to the molten glass gob is such that the next molten glass gob to be processed in the same shaping means in a subsequent processing cycle is applied with a lower dosage of dispersion; and/or
   (iii) the amount of lubricating dispersion applied to the molten glass gob is such that no dispersion is applied to the next molten glass gob which is to be processed in the same shaping means in a subsequent processing cycle; and/or
   (iv) the solid lubricant is graphite; and/or
   (v) the only solid lubricant is graphite; and/or
   (vi) the solid lubricant has a d₉₀ of less than about 150 microns; and/or
   (vii) the lubricant dispersion is water-based; and/or
   (viii) the lubricant dispersion comprises dispersant and/or rheology modifier; and/or
   (ix) the molten glass gob is stationary as the lubricating dispersion is applied; and or
   (x) the lubricating dispersion applied does not produce carbon black following application to the molten glass gob and/or during processing of the molten glass gob into a shaped article; and/or
   (xi) the temperature, for example, bulk temperature of the molten glass gob is not adversely affected by application of the lubricating dispersion.
19. A self-lubricating system configured to implement the method according to any preceding paragraph, the system comprising one or more molten glass gobs that act as a carrier for a lubricating dispersion including a solid lubricant to lubricate at least one surface of the system to which it comes into contact, wherein:
   (i) the temperature, for example, bulk temperature of the molten glass gob is not adversely affected by application of the lubricating dispersion; and/or
   (ii) the only solid lubricant is graphite; and/or
   (iii) the only lubricant is graphite; and/or
   (iv) the solid lubricant has a d₉₀ of less than about 150 microns; and/or
   (v) the lubricant dispersion is water-based; and/or
   (vi) the lubricant dispersion comprises dispersant and/or rheology modifier; and/or
   (vii) the lubricating dispersion applied does not produce carbon black following application to the molten glass gob and/or during processing of the molten glass gob into a shaped article.
20. A self-lubricating system according to paragraph 19, wherein the molten glass gob is processed in the system to obtain a shaped article therefrom.
21. A molten glass gob having a lubricant dispersion applied to a surface thereof, wherein:
   (i) the temperature, for example, bulk temperature of the molten glass gob is not adversely affected by application of the lubricating dispersion; and/or
   (ii) the only solid lubricant is graphite; and/or
   (iii) the only lubricant is graphite; and/or
   (iv) the solid lubricant has a d₉₀ of less than about 150 microns; and/or
   (v) the lubricant dispersion is water-based; and/or
   (vi) the lubricant dispersion comprises dispersant and/or rheology modifier; and/or
   (vii) the lubricating dispersion applied does not produce carbon black following application to the molten glass gob and/or during processing of the molten glass gob into a shaped article.
22. A molten glass gob having a lubricant dispersion applied to a surface thereof, wherein from about 1 percent to about 50 percent of the surface has lubricant dispersion applied thereto.
23. Use of a molten glass gob according to paragraph 21 or 22 for transferring lubricant in a system requiring lubrication.
24. A method of using a molten glass gob according to paragraph 21 or 22, the method comprising using the molten glass gob to transfer lubricant to a part or parts of a system requiring lubrication.
25. Use of a molten glass gob according to paragraph 21 or 22 for improving efficiency in a system requiring lubrication.
26. A method of using a molten glass gob according to paragraph 21 or 22 for improving efficiency in a system requiring lubrication, the method comprising using the molten glass gob to transfer lubricant to a part or parts of the system such that efficiency is improved.
27. Use of a molten glass gob according to paragraph 21 or 22 for reducing waste in a system requiring lubrication.
28. A method of using a molten glass gob according to paragraph 21 or 22 for reducing waste in a system requiring lubrication, the method comprising using the molten glass gob to transfer lubricant to a part or parts of the system such that waste is reduced.
29. Use of a molten glass gob according to paragraph 21 or 22 for reducing the amount of lubricant used in a system requiring lubrication.
30. A method of using a molten glass gob according to paragraph 21 or 22 for reducing the amount of lubricant used in a system requiring lubrication, the method comprising using the molten glass gob to transfer lubricant to a part or parts of the system such that the amount of lubricant used is reduced.
31. Use of a molten glass gob according to paragraph 21 or 22 for increasing the utilization rate of shaping means in a system for shaping a molten glass gob, wherein a lubricating dispersion including a solid lubricant is applied to the molten glass gob prior to shaping the molten glass gob in the shaping means.
32. A method of using a molten glass gob according to paragraph 21 or 22 for increasing the utilization rate of shaping means in a system for shaping a molten glass gob, wherein a lubricating dispersion including a solid lubricant is applied to the molten glass gob prior to shaping the molten glass gob in the shaping means.
33. A method, system or use according to any preceding paragraph, wherein the lubricating dispersion is applied by spraying.
34. A method, system or use according to any one of numbered paragraphs 1-32, wherein the lubricating dispersion is applied by brushing.
35. A method, system or use according to any one of numbered paragraphs 1-32, wherein the solid lubricant is applied by electrostatic discharge on the molten glass gob it is passes or is passed through a lubricating dispersion comprising powdered solid lubricant.
36. A method, system or use according to any one of numbered paragraphs 1-32, wherein the lubricating dispersion is applied as the molten glass gob passes through or is passed through a body of lubricant dispersion.
37. A method, system or use according to any one of numbered paragraphs 1-32, wherein the lubricating dispersion is applied by dipping or submersing the molten glass gob in a body of lubricant dispersion.
38. A method, system or use according to any preceding paragraph, wherein the lubricating dispersion is a liquid-based lubricating dispersion.
39. A method, system or use according to paragraph 38, wherein the lubricating dispersion is water-based.
40. A method, system or use according to any preceding paragraph, wherein the solid lubricant is graphite.
41. A method, system or use according to any preceding paragraph, wherein the solid lubricant has a d₉₀ of less than about 150 microns.
42. A method, system or use according to any preceding, wherein the lubricating dispersion comprises dispersant and/or rheology modifier.
43. A method, system or use according to any preceding paragraph, wherein less than about 50 percent of the molten glass gob have lubricating dispersion applied.
44. A method, system or use according to any preceding paragraph, wherein the molten glass gob is formed from a composition comprising one or more of cullet, quartz sand, and soda.
45. A method system or use according to any preceding paragraph, wherein the molten glass gob is formed from a composition comprising from about 20 percent to about 90 percent by weight cullet.
46. A method according to any preceding method paragraph, wherein a glass article is formed from the molten glass gob, and the glass article is inspected and/or packaged for distribution.
47. A system according to any preceding system paragraph, wherein the system additionally comprises an inspection zone and/or a packaging zone.

For the avoidance of doubt, the present application is also directed to the subject-matter described in the following numbered paragraphs:
1A. A method comprising coating glass gobs, with a liquid-based lubricating dispersion during their drop to blank container molds, wherein:
   (i) the liquid-based lubricating dispersion comprises a solid lubricant having a d₉₀ of below 150 microns; and/or
   (ii) the liquid-based lubricating dispersion comprises a solid lubricant that is graphite; and/or
   (iii) the glass gobs are free falling.
2A. A method according to numbered sentence 1A, which provides sufficient lubrication to the article container molds without requiring swabbing of the container molds.
3A. A method for lubrication of article container manufacturing molds, said method comprising coating glass gobs with a liquid-based lubricating dispersion during their drop to blank container molds which provides sufficient lubrication to the container molds without requiring swabbing of the container molds.
4A. A method according to any one of numbered sentences 1A-3A, wherein the liquid-based lubricating dispersion comprises a solid lubricant having a d₉₀ below 150 microns, optionally wherein the solid lubricant is graphite.
5A. A system for implementing the method according to any one of numbered sentences 1A-4A, wherein the system comprises a liquid-based lubricating dispersion, and wherein:
   (i) the liquid-based lubricating dispersion comprises a solid lubricant having a d₉₀ of below 150 microns; and/or
   (ii) the liquid-based lubricating comprises a solid lubricant that is graphite; and/or
   (iii) the system is configured such that the glass gobs are free falling during coating.
6A. Use of a liquid-based lubricating dispersion in a system according to numbered sentence 5A or for coating glass gobs during their drop to blank container molds, wherein:
   (i) the liquid-based lubricating dispersion comprises a solid lubricant which has a d₉₀ below 150 microns; and/or
   (ii) the solid lubricant is graphite; and/or
   (iii) the glass gobs are free falling during coating.
7A. A method of applying falling glass gobs with a liquid-based lubricating dispersion to lubricate them prior to their entry into blank molds, wherein:
   (i) the liquid-based lubricating dispersion comprises a solid lubricant having a d₉₀ of below 150 microns; and/or
   (ii) the liquid-based lubricating dispersion comprises a dispersing agent and/or a rheology modifier; and/or
   (iii) wherein the glass gobs are free falling.
8A. A method for at least minimizing the need for lubricating every glass gob, said method comprising applying falling glass gobs with a lubricating dispersion to lubricate them prior to their entry into blank molds.
9A. A method according to numbered sentence 7A or 8A, wherein the lubricating dispersion is applied onto the falling glass gobs after they have been cut by a shears mechanism from a molten stream supplied by a gob feeder, and before the falling glass gobs enter funnels leading to scoops, troughs and deflectors in a gob distribution system which distributes them to the blank molds.
10A. A method according to any one of numbered sentences 7A-9A, wherein the glass gobs are coated with the lubricating dispersion, optionally wherein the lubricating dispersion is applied by spraying.
11A. A method according to any one of numbered sentences 7A-10A, wherein the lubricating dispersion is a liquid-based lubricating dispersion comprising a solid lubricant having a d₉₀ below 150 microns, optionally wherein the solid lubricant is graphite.
12A. A system for implementing the method according to any one of numbered sentences 7A-11A, wherein:
   (i) the system comprises a lubricating dispersion comprising a solid lubricant having a d₉₀ of below 150 microns; and/or
   (ii) the lubricating dispersion comprises a dispersing agent and/or a rheology modifier; and/or
   (iii) the system is configured such that the glass gobs are free falling during application of the lubricating dispersion.
13A. Use of a lubricating dispersion in a system according to numbered sentence 12A or for lubricating falling glass gobs prior to their entry into blank molds, wherein:
   (i) the lubricating dispersion comprises a solid lubricant having a d₉₀ below 150 microns; and/or
   (ii) the lubricating dispersion comprises a dispersing agent and/or a rheology modifier; and/or
   (iii) the glass gobs are free falling during application of the lubricating dispersion.
14A. A method for applying a lubricating dispersion comprising a solid lubricant to free falling glass gobs, wherein:
   (i) the lubricating dispersion comprises a solid lubricant having a d₉₀ of below 150 microns; and/or
   (ii) the lubricating dispersion comprises a dispersing agent and/or a rheology modifier.
15A. A method according to numbered sentence 14A, wherein the glass gobs are not in contact with any portion of a shapeable mass distribution system during application of the lubricating dispersion.
16A. A method according to numbered sentence 14A or 15A, wherein the lubricating dispersion is a liquid-based lubricating dispersion.
17A. A method according to any one of numbered sentences 14A-16A, additionally providing lubrication to a gob distribution system.
18A. A system for implementing the method of any one of numbered sentences 14A-17A, for example, a gob distribution system, wherein:
   (i) the system comprises a lubricating dispersion comprising a solid lubricant having a d₉₀ of below 150 microns; and/or
   (ii) the lubricating dispersion comprises a dispersing agent and/or a rheology modifier.
19A. Use of a lubricating dispersion in a system according to numbered sentence 18A or for lubricating free falling glass gobs, wherein:
   (i) the lubricating dispersion comprises a solid lubricant having a d₉₀ below 150 microns; or
   (ii) the lubricating dispersion comprises a dispersing agent and/or a rheology modifier.
20A. A method for applying a lubricating dispersion to falling glass gobs, said method comprising applying the lubricating dispersion to the falling glass gobs as they fall through an enclosure.
21A. A method according to numbered sentence 20A, wherein:
   (i) the system comprises a liquid-based lubricating dispersion; and/or
   (ii) the lubricating dispersion comprises a solid lubricant having a d₉₀ of below 150 microns; and/or
   (iii) the lubricating dispersion comprises a dispersing agent and/or a rheology modifier.
22A. A method according to numbered sentence 20A or 21A, wherein the lubricating dispersion is applied via a plurality of nozzles mounted in or adjacent to the enclosure, each of the nozzles being arranged and configured to apply the lubricating dispersion therefrom, optionally wherein the lubricating dispersion is applied periodically to one glass out of a series of N glass gobs, wherein N varies from 2 to 30.
23A. A method according to any one of numbered sentences 20A-22A, wherein the lubricating dispersion is a liquid-based lubricating dispersion.
24A. A method according to any one of numbered sentences 20A-23A, wherein the lubricating dispersion comprises a solid lubricant having a d₉₀ of less than 150 microns.
25A. A method according to any one of numbered sentences 20A-24A, wherein the lubricating dispersion is applied to the falling glass gobs by spraying.
26A. A system for implementing the method according to any one of numbered sentences 20A-25A, optionally wherein:
   (i) the system comprises a liquid-based lubricating dispersion; and/or
   (ii) the system comprises a lubricating dispersion which comprises a solid lubricant having a d₉₀ of below 150 microns; and/or
   (iii) the system comprises a lubricating dispersion which comprises a dispersing agent and/or a rheology modifier.
27A. Use of a lubricating dispersion in a system according to numbered sentence 26A or for lubricating falling glass gobs as they fall through an enclosure, optionally wherein:
   (i) the lubricating dispersion is a liquid-based lubricating dispersion; and/or
   (ii) the lubricating dispersion comprises a solid lubricant has a d₉₀ below 150 microns; and/or
   (iii) the system comprises a lubricating dispersion which comprises a dispersing agent and/or a rheology modifier.
28A. A method, system or use according to any preceding numbered sentence, further comprising recycling any excess lubricating dispersion.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be claimed alone or in combination with any of the features, elements, or components of any of the other embodiments discussed above.

1. A method of lubricating a surface of a part or parts of a system using one or more molten glass gobs having a lubricant dispersion including a solid lubricant applied thereto to transfer lubricant to said part or parts of the system wherein:
(i) the amount of lubricating dispersion applied to the molten glass gob is such that an amount of lubricant that transfers from the molten glass gob to a surface of the part or parts of the system with which the molten glass gob comes into contact is sufficient for lubricating the part(s) during at least one further processing cycle of a molten glass gob which is to be processed in the system; and/or
(ii) the amount of lubricating dispersion applied to the molten glass gob is such that the next molten glass gob to be processed in the same shaping means in a subsequent processing cycle is applied with a lower dosage of dispersion; and/or
(iii) the amount of lubricating dispersion applied to the molten glass gob is such that no dispersion is applied to the next molten glass gob which is to be processed in the same shaping means in a subsequent processing cycle; and/or
(iv) the solid lubricant is graphite; and/or
(v) the only solid lubricant is graphite; and/or
(vi) the solid lubricant has a d₉₀ of less than about 150 microns; and/or
(vii) the lubricant dispersion is water-based; and/or
(viii) the lubricant dispersion comprises dispersant and/or rheology modifier; and/or
(ix) the molten glass gob is stationary as the lubricating dispersion is applied; and or
(x) the lubricating dispersion applied does not produce carbon black following application to the molten glass gob and/or during processing of the molten glass gob into a shaped article; and/or
(xi) the temperature, for example, bulk temperature of the molten glass gob is not adversely affected by application of the lubricating dispersion.

2. A method for improving the efficiency of a system requiring lubrication, the method comprising:
applying a liquid-based lubricating dispersion including a solid lubricant to a molten glass gob which is to be processed in the system, such that or whereby the efficiency of the system is improved.

3. A method of reducing waste in a system requiring lubrication, the method comprising:
applying a liquid-based lubricating dispersion including a solid lubricant to a molten glass gob which is to be processed in the system, such that or whereby waste is reduced.

4. A method according to claim 2, wherein efficiency is improved relative to a system in which (A) a lubricant is applied either (i) manually to a part or parts of the system or (ii) by flame or plasma spraying a molten glass gob, or (B) the lubricating composition applied produces carbon black following application to the molten glass gob and/or during processing of the molten glass gob into a shaped article.

5. A method according to claim 2, wherein efficiency is improved by at least about 1 percent, for example, at least about 2 percent, or at least about 5 percent, or at least about 10 percent.

6. A method according to claim 2, wherein the lubricating dispersion is applied to the molten glass gob prior to contact with a part or parts of the system in which the molten glass gob is processed to form a shaped article.

7. A method according to claim 1, wherein the amount of lubricating dispersion applied to the molten glass gob is such that (i) an amount of lubricant transfers from the molten glass gob to a surface(s) of the part(s) of the system in which the molten glass gob comes into contact and which is sufficient for lubricating the part(s) during at least one subsequent processing cycle of a further molten glass gob, or (ii) the next molten glass gob to be processed in the same shaping means in a subsequent processing cycle is applied with a lower dosage of dispersion, or (ii) no dispersion is applied to the next molten glass gob which is to be processed in the same shaping means in a subsequent processing cycle.

8. A method according to claim 1, wherein the molten glass gob is in motion, for example, free falling as the lubricating dispersion is applied.

9. A method according to claim 1, wherein the molten glass gob is stationary as the lubricating dispersion is applied.

10. A method according to claim 9, wherein the lubricating dispersion is applied immediately following forming of the molten glass gob.

11. A method according to claim 1, wherein the molten glass gob is (i) enclosed as the lubricating dispersion is applied, or (ii) is not enclosed as the lubricating dispersion is applied.

12. A method of increasing the utilization rate of shaping means in a system for shaping a molten glass gob, said method comprising:
applying a liquid-based lubricating dispersion including a solid lubricant to the molten glass gob prior to shaping the molten glass gob in the shaping means.

13. A method of reducing the amount of lubricant used in a system requiring lubrication, said method comprising:
applying a liquid-based lubricant dispersion to a molten glass gob to be processed in the system such that lubricant is transferred from the molten glass gob to a part of parts of the system requiring lubrication, thereby reducing the amount of lubricant used in the system.

14. A method according to claim 12, wherein the utilization rate is increased relative to a system in which (A) a lubricant is applied either (i) manually to a part or parts of the system, or (ii) by flame or plasma spraying a molten glass gob which is to be processed in the system, or (iii) to every molten glass gob which is processed according to the method or in the system; or (B) the lubricating composition applied produces carbon black following application to the molten glass gob and/or during processing of the molten glass gob into a shaped article.

15. A method according claim 12, wherein the utilization rate is increased by, and/or the amount of lubricant used is reduced by, at least 1 percent.

16. A method according to claim 1, wherein the lubricating dispersion is applied by brushing.

17. A method according to claim 1, wherein the solid lubricant is applied by electrostatic discharge on the molten glass gob as it is passes or is passed through a lubricating dispersion comprising powdered solid lubricant.

18. A method according to claim 1, wherein the lubricating dispersion is applied as the molten glass gob passes through or is passed through a body of lubricant dispersion.

19. A method according to claim 1, wherein the lubricating dispersion is applied by dipping or submersing the molten glass gob in a body of lubricant dispersion.

20. A method according to claim 3, wherein waste is reduced relative to a system in which (A) a lubricant is applied either (i) manually to a part or parts of the system or (ii) by flame or plasma spraying a molten glass gob, or (B) the lubricating composition applied produces carbon black following application to the molten glass gob and/or during processing of the molten glass gob into a shaped article.

21. A method according to claim 13, wherein the reduction in the amount of lubricant used is reduced relative to a system in which (A) a lubricant is applied either (i) manually to a part or parts of the system, or (ii) by flame or plasma spraying a molten glass gob which is to be processed in the system, or (iii) to every molten glass gob which is processed according to the method or in the system; or (B) the lubricating composition applied produces carbon black following application to the molten glass gob and/or during processing of the molten glass gob into a shaped article.
